(19) United States
(12) Patent Application Publication
(10) Pub. No.: US 2010/0252750 A1
(43) Pub. Date: Oct. 7, 2010

(54) SYSTEMS AND METHODS FOR STIMULATED EMISSION IMAGING

(76) Inventors: Xiaoliang Sunney Xie, Lexington, MA (US); Wei Min, Cambridge, MA (US); Sijia Lu, Cambridge, MA (US)

Correspondence Address: GAUTHIER & CONNORS, LLP, 225 FRANKLIN STREET, SUITE 2300, BOSTON, MA, 02110, US

(21) Appl. No.: 12/417,993

(22) Filed: Apr. 3, 2009

(51) Int. Cl. G01J 1/58

(52) U.S. Cl. 250/459.1; 250/458.1

(57) ABSTRACT

A microscopy imaging system is disclosed that includes a light source system, focusing optics, an optical detector and a processor. The light source system is for providing an excitation beam at a center optical frequency ωₑ and for providing a stimulation beam at a center optical frequency ωₛ. The focusing optics is for directing and focusing the excitation beam toward a common focal volume such that a sample may be excited to an electronic excited state, and for directing and focusing the stimulation beam toward the common focal volume such that stimulated emission induced from the electronic excited state results in an increase in intensity of the stimulated beam. The optical detector is for detecting an increase in a radiation field at the center optical frequency ωₛ from stimulated emission from the common focal volume and for providing a detector signal. The processor is for receiving the detector signal and for providing a pixel of an image for the microscopy imaging system. In certain embodiments, the stimulated emission imaging allows detection and imaging of non-fluorescent chromophores such as drug molecules, small dye molecules and proteins in living cells, tissues and organisms with intrinsic 3D optical sectioning and high sensitivity.

### BACKGROUND

The invention generally relates to imaging systems, and relates in particular to microscopy systems and methods.

Fluorescence microscopy has been widely used in biomedical sciences because of its high sensitivity and specificity. M any light-absorbing chromophores however, such as hemoglobin and cytochromes, have extremely low fluorescent quantum yields due to the much faster non-radiative decay rate than the spontaneous emission rate. In such cases, the remaining feeble fluorescence signal is overwhelmed by various background signals including stray light, solvent Raman background and detector dark counts, etc. Molecular contrasts other than fluorescence, therefore, would be highly beneficial for sensitive detection and imaging of these chromophores with non-detectable fluorescence.

Various types of fluorescence-free spectroscopy have been employed to image those chromophores, including photothermal (see “Label-Free Optical Imaging of Mitochondria in Live Cells” by D. Lasne, G. A. Blab, F. De Giorgi, R. Ichas, B. Lounis, and L. Cognet, Optics. Express vol. 15, no. 21, pp. 14184-14193 (Oct. 17, 2007)) and two-photon absorption (see “High-Resolution in vivo Imaging of Blood Vessels without Labeling” by Fu, D., Ye, T., Matthews, T. E., Chen, B. J., Yurtserver, G. & Warren, W. S., Optics Letters, vol. 32, no. 18, pp. 2641-2643 (Sep. 15, 2007)). These methods however, are still very limited in detection sensitivity.

The detection of single molecule absorption was previously achieved in cryogenic temperatures using frequency modulation (see “Optical Detection and Spectroscopy of Single Molecules in a Solid” By Moerner, W. E. & Kador, L., Phys. Rev. Lett. vol. 62, no. 21, p. 2535-2538 (May 22, 1989)). It is difficult however, to implement at room temperatures because of the broad absorption spectrum.

Surface enhanced Raman scattering (SERS) at electronic resonance has been achieved with single molecule sensitivity for those molecules having correct orientations with respect to metallic structures (see “Probing Single Molecules and Single Nanoparticles by Surface-Enhanced Raman Scattering” by Nie S, Emory S R., Science, vol. 275, pp. 1102-1106, (Feb. 21, 1997)); and “Single Molecule Detection Using Surface-Enhanced Raman Scattering (SERS)” by Kneipp K, Wang Y, Kneipp H, Perelman L T, Itzkan I, et al., Phys. Rev. Lett., vol. 78, no. 9, pp. 1667-1670 (Mar. 3, 1997)). The introduction however, of metal particles perturbs the sample and not all molecules in the sample can be accessed by SERS.

There is a strong need therefore, for a microscopy system and method for providing improved sensitivity in imaging chromophores, and in particular, for providing a microscopy system that permits imaging of light absorbing subjects having extremely low fluorescence.

### SUMMARY

The invention provides a microscopy imaging system in accordance with an embodiment of the invention that includes a light source system, focusing optics, an optical detector and a processor. The light source system is for providing an excitation beam at a center optical frequency ωₑ and for providing a stimulation beam at a center optical frequency ωₛ. The focusing optics is for directing and focusing the excitation beam toward a common focal volume such that an energy level of a sample may be excited to an electronic excited state, and for directing and focusing the stimulation beam toward the common focal volume such that stimulated emission induced from the electronic excited state results in an increase in intensity of the stimulation beam. The optical detector is for detecting an increase in a radiation field at the center optical frequency ωₛ from stimulated emission from the common focal volume and for providing a detector signal. The processor is for receiving the detector signal and for providing a pixel of an image for the microscopy imaging system.

The invention also provides a method of performing microscopy imaging that includes the steps of an providing excitation beam at a center optical frequency ωₑ, providing a stimulation beam at a center optical frequency ωₛ; directing and focusing the excitation beam toward a common focal volume such that an energy level of a sample may be excited to an electronic excited state; directing and focusing the stimulation beam from the stimulation illumination toward the common focal volume such that stimulated emission induced from the electronic excited state results in an increase in intensity of the stimulation beam; detecting an increase in a radiation field at the center optical frequency ωₛ from stimulated emission from the common focal volume; providing a stimulated emission detector signal responsive to the increase in the radiation field at the center optical frequency ωₛ from stimulated emission from the common focal volume; and providing at least a portion of an image responsive to the stimulated emission detector signal.

In certain embodiments, the stimulated emission imaging of the invention allows detection and imaging of non-fluorescent chromophores such as drug molecules, small dye molecules and proteins in living cells, tissues and organisms with intrinsic 3D optical sectioning and high sensitivity.

### BRIEF DESCRIPTION OF THE DRAWINGS

The following description may be further understood with reference to the accompanying drawings in which:

FIG. 1 shows an illustrative diagrammatic view of an energy diagram of spontaneous emission, non-radiative decay, and stimulated emission in accordance with an embodiment of the invention;

FIG. 2 shows an illustrative diagrammatic view of the functionality of a portion of a system for performing stimulated emission analysis in accordance with an embodiment of the invention;

FIGS. 3A and 3B show illustrative graphical representations of input and output excitation and stimulation pulse trains for use in accordance with an embodiment of the invention;

FIG. 4 shows an illustrative diagrammatic view of a system for performing stimulated emission microscopy in accordance with an embodiment of the invention;

FIG. 5 shows a diagrammatic graphical representation of a range of time delays between excitation and stimulation signals versus corresponding signals (in arbitrary units) in a system in accordance with an embodiment of the invention;

FIG. 6 shows a diagrammatic graphical representation of a stimulation wavelength spectra for crystal violet in glycerol solution using a system in accordance with an embodiment of the invention;

FIG. 7 shows an illustrative graphical representation of excitation and stimulation center wavelengths in a system in accordance with an embodiment of the invention from which the stimulation wavelength spectra of FIG. 6 was obtained;

FIG. 8 shows an illustrative graphical representation of measured stimulated emission signals for a range of concentrations of crystal violet in glycerol solution using a system in accordance with an embodiment of the invention;

FIG. 9 shows an illustrative micro-photographic representation of imaging distributions of cytoplasmic chromoproteins gtCP in live E coli cells by stimulated emission microscopy in accordance with an embodiment of the invention;

FIG. 10 shows an illustrative micro-photographic representation of a direct wide field transmission image of the sample of FIG. 9;

FIG. 11 shows an illustrative micro-photographic representation of imaging distributions of cytoplasmic chromoproteins cjBlue in live E coli cells by stimulated emission microscopy in accordance with an embodiment of the invention;

FIG. 12 shows an illustrative micro-photographic representation of a direct wide field transmission image of the sample of FIG. 11;

FIGS. 13A and 13B show illustrative micro-photographic representations of stimulated emission images of lacZ gene expression probed by the hydrolysis of chromogenic substrate X-gal in a system in accordance with an embodiment of the invention;

FIG. 14 shows an illustrative a micro-photographic representation of a direct wide field transmission image of the sample of FIG. 13B;

FIG. 15 shows an illustrative micro-photographic representation of a three dimensional optical sectioning of kidney tissue by stimulated emission microscopy in a system in accordance with an embodiment of the invention;

FIG. 16 shows an illustrative micro-photographic representation of drug delivery of Toluidine blue O (TBO) in a human embryonic kidney in a system in accordance with an embodiment of the invention; and

FIGS. 17 and 18 show illustrative micro-photographic representations of TBO skin distribution at two different depths in a system in accordance with an embodiment of the invention.

The drawings are shown for illustrative purposes only.

### DETAILED DESCRIPTION OF THE ILLUSTRATED EMBODIMENTS

Fluorescence is a powerful contrast mechanism used in molecular imaging due to its high sensitivity. Many light-absorbing chromophore molecules however, are only weakly fluorescent, because of their fast non-radiative decay. The feeble fluorescence from such chromophores is often overwhelmed by various background signals including stray light, solvent Raman background and detector dark counts, etc. Various fluorescence-free techniques have been developed, but are often limited by their weak signals.

The present invention provides a new contrast mechanism for room temperature imaging systems that is based on stimulated emission. The radiative emission rate from the molecular excited state is significantly amplified by virtue of stimulated emission, which converts the originally non-, or weakly radiating species into highly radiating. The superb sensitivity is accomplished by implementation of high-frequency (MHz) phase-sensitive detection. The overall nonlinear intensity dependence of the stimulated emission signal also offers an intrinsic three-dimensional optical sectioning capability.

For example, in accordance with certain embodiments, the invention provides orders-of-magnitude improvement of detection sensitivity for non-fluorescent chromophores by use of stimulated emission that dominates the non-radiative decay. In a femtosecond pump-probe experiment, shortly after optical excitation by the pump pulses, the probe pulses stimulate the transition from the molecular excited state down to the ground state, and at the same time, experience a light amplification after passing through the molecules. Such a stimulated emission signal is extracted by implementing high-frequency (MHz) phase sensitive detection with high sensitivity. The resulting signal is linearly dependent on both the pump and probe intensities, offering intrinsic three-dimensional optical sectioning capability for microscopy. A variety of applications of this technique are demonstrated, such as visualizing distributions of chromoproteins, non-fluorescent variants of the green fluorescent protein, in live bacteria, monitoring basal level lacZ gene expression based on chromogenic substrate, 3D optical sectioning of medically stained tissues, and imaging subcellular distribution and transdermal delivery of a drug used in photodynamic therapy. The microscopic technique also opens up the possibility for studying the biochemistry of endogenous proteins such as cytochromes and hemoglobin without labeling.

The phenomenon of stimulated emission was first described by Albert Einstein in 1917 in term of Einstein's B coefficients. An atom or molecule in its excited state can be stimulated down to the ground state by an incoming light field, resulting in the creation of a new photon identical to those in the incoming field. This process only occurs when the frequency of the incoming field matches the energy gap between the ground and the excited state. Stimulated emission is the basis for light amplification in laser. The depopulation aspect of stimulated emission has been successfully used for population dumping from molecular excited states, super-resolution fluorescence microscopy, and fluorescence lifetime imaging. The present invention utilizes the light amplification aspect of stimulated emission as a contrast mechanism for high-sensitivity microscopy.

The minimal spontaneous emission from weakly fluorescent chromophores, is overwhelmed by various background signals, such as stray light, solvent Raman scattering, detector dark counts, etc. due to the non-radiative decay rate being much faster than the spontaneous emission rate (i.e., Einstein's A coefficient). Applicants have discovered that a solution to this problem is to probe the short lived excited state by stimulated emission that dominates the non-radiative decay. In a pump-probe experiment, shortly after photo-excitation of the chromophore, stimulated emission is induced by a stimulation pulse during the short excited state lifetime, resulting in an increase in the stimulation beam's photon flux, which can be detected against the background. The approach of the present invention introduces an external coherent laser field to greatly stimulate the radiative emission from the electronic excited state after the chromophore is optically excited but before its non-radiative decay dominates.

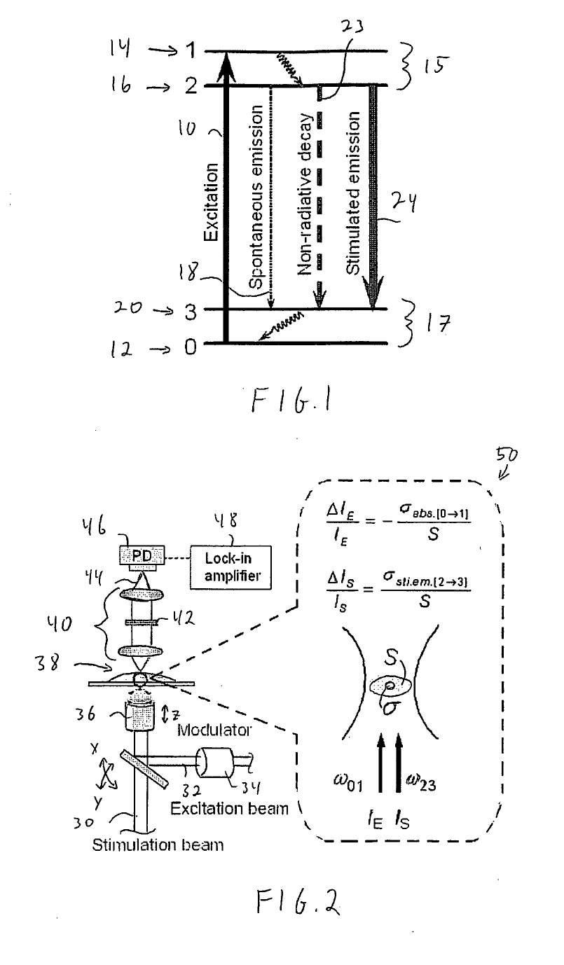

The invention, therefore, involves stimulating emission of non-fluorescent or weakly fluorescent samples at an electronic excited state. As shown in the energy diagram in FIG. 1, for example, an excitation field 10 applied for example to a dye molecule, may cause a sample to be excited to an electronic ex cited state 15 (e.g., change from a first energy state 12 to a second higher energy state 14, whereupon it settles or relaxes to a slightly lower third energy state 16). If the sample were fluorescent, a spontaneous fluorescent emission would occur as shown at 18, bringing the energy level back down to an electronic non-excited state 17 (e.g., from the relaxed state of the higher energy level 16 to a lower energy state 20, whereupon it would then settle or relax to the slightly lower original energy state 10). If the sample is non-fluorescent, a non-radiative decay will occur as shown at 22 between energy states 16 and 20.

The invention provides that prior to the non-radiative decay in a non-fluorescent or weakly fluorescent sample, a stimulated emission may be extracted as shown at 24 from the energy state 16, which is the relaxed state of the higher energy level, to the energy state 20. In accordance with an embodiment, consecutive optical excitation at one wavelength ω₀₁ and stimulated emission at a longer wavelength ω₂₃ may be provided. Spontaneous emission is much slower than the non-radiative decay in weakly or non-fluorescent chromophores. When the stimulation field is designed to have the correct energy and timing, the stimulated emission can be the dominating decay pathway.

The excitation field and stimulation field may be provided as a stimulation beam 30 and an excitation beam 32 as shown in FIG. 2. In an embodiment of the invention, each of the stimulation beam 30 and the excitation beam 32 may be provided as synchronized trains of pulses that are slightly offset from one another in a stimulated emission microscopy system. In accordance with other embodiments, the stimulation beam 30 may comprise a continuous wave (cw) stimulation field at a center frequency ωₛ and the excitation beam 32 may comprise a cw excitation field at a center frequency ωₑ. In such an embodiment, the stimulated emission would result from the cw excitation beam exciting the sample to an electronic excited state, followed by the cw stimulation beam inducing stimulated emission from the electronic excited state. In accordance with further embodiments, one of the excitation field and the stimulation field may be provided as a cw wave while the other is provided as a train of pulses.

With reference again to FIG. 2, the input stimulation beam 30 and excitation beam 32 (as modulated by a modulator 34) are combined by optics 31 (such as an x, y scanning combiner mirror) to provide spatially overlapped beams as a single beam in which the stimulation beam and the modulated excitation beam are collinear. The single collinear beam is focused by an objective 36 (optionally adjustable in the z direction) onto a common focal spot 38. The modulator 34 turns the intensity of the excitation beam on-and-off at 5 MHz. The spectrally filtered stimulation beam 44 is received by optics 40 (including a filter 42) and is detected by a large-area photodiode 46, that is demodulated by a lock-in amplifier 48 to create the image contrast while scanning the beam. The inset shown at 50 illustrates the energy gain or loss of the stimulation beam and excitation beam, respectively, for a single chromophore (S) at the focus.

The molecular absorption cross section σ_{abs} for a single chromophore in solution at room temperature is ˜10⁻¹⁶ cm². Under a tightly focused laser beam with a beam waist area of S (˜10⁻⁹ cm² for visible light focused by a high numerical aperture objective), the integrated intensity attenuation of the excitation beam, ΔI_{E}/I_{E}, is proportional to the ratio between σ_{0→1} and S:

ΔI_{E}/I_{E}≈−N₀·σ_{0→1}/S (1)

where N₀ is the number of molecules in ground state. For a single chromophore, i.e. N₀=1, ΔI_{E}/I_{E} is on the order of 10⁻⁷. Attenuation magnitude at such a scale cannot be detected by conventional absorption microscopy. It is noted that single molecule absorption has been previously achieved in cryogenic temperatures using frequency modulation, which is difficult to implement because of the broad absorption spectrum at room temperatures. Instead of detecting direct absorption, the invention provides detecting stimulated emission followed by absorption.

The molecular cross section σ_{sti.em} for stimulated emission, which is proportional to Einstein's B coefficient, is comparable to σ_{abs}. Similarly, the intensity gain of the stimulated emission beam, ΔI_{S}/I_{S}, is as follows

ΔI_{S}/I_{S}≈N₂·σ_{2→3}/S (2)

where N₂ is the number of excited molecules interrogated by the stimulation pulses. For a single chromophore residing in level 2, i.e., N₂=1, ΔI_{S}/I_{E} is also on the order of 10⁻⁷.

Such a small amplification is again often buried in the laser noise (˜1%) of the stimulated emission beam. By implementation of a high-frequency (higher than MHz) intensity modulation technique however, the laser noise, which occurs primarily at low frequency (kHz to DC), may be sufficiently suppressed.

In the dual beam scheme, N₂ in Equation (2) above originates from linear optical excitation: N₂ ∝ N₀·I_{E}·σ_{0→1}/S. This relation, together with Equation (2), indicates that the final signal ΔI_{S} is linearly dependent on both I_{E} and I_{S}, i.e.,

ΔI_{S}∝N₀·I_{E}·I_{S}·(σ_{0→1}/S)·(σ_{2→3}/S).

The detected stimulated emission signal depends on the product of the excitation beam intensity and the stimulated beam intensity. The signal, therefore, has an overall second order nonlinear intensity dependence, which provides high spatial resolution.

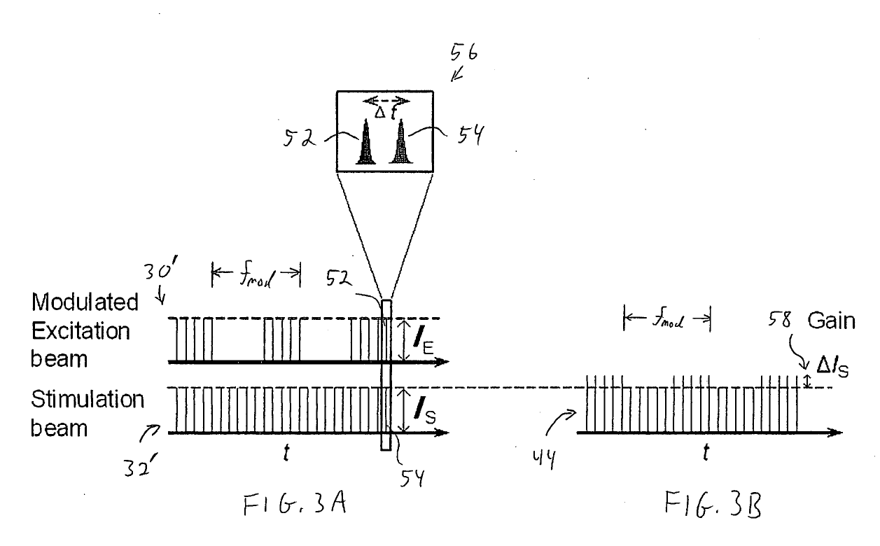

With reference to FIGS. 3A and 3B in which beams 30 and 32 are provided as trains of pulses, the modulated train of excitation pulses 30′ and the train of stimulation pulses 32′ are timed such that each individual excitation pulse 54 (having a center frequency of ω_{c}) follows a respective stimulation pulse 52 (having a center frequency of ωₛ) by a time delay Δt as shown at 56 of, for example, about 0.2 ps. The modulation of the excitation train of pulses at a modulation frequency of f_{mod} is used by the detector to remove the original stimulation illumination from the received filtered illumination 44, providing a small gain in illumination at the stimulation frequency ωₛ as shown at 58, which yields the illumination of interest.

In specific examples, 200 fs pulses may be used for excitation and stimulation as they are shorter than the excited state lifetime (sub-ps) of certain chromophores. The stimulation pulses may be delayed with respect to the excitation pulses by ˜200 fs in order for the vibrational relaxation to complete from level 1 to level 2 (shown at 14 and 16 in FIG. 1), but before the non-radiative decay starts from level 2 to level 3 (shown at 16 and 18 in FIG. 1).

In particular, the intensity of the excitation beam is modulated, e.g., at 5 MHz, and this creates a modulation of the stimulated emission signal at the same frequency, because only when the excitation beam is present can the gain of the stimulated beam occur. Such an induced modulation signal can be sensitively extracted by the lock-in amplifier at 5 MHz, at which the laser noise is lower than 10⁻⁷. In this way, the dual beam modulation transfer scheme herein offers a superior sensitivity over the direct one-beam absorption detection.

The temporal delay between excitation and stimulation pulses is adjustable in certain embodiments by using a delay unit such as a translational stage for either one of the excitation and stimulation trains of pulses. In other embodiments, the delay may be provided within the laser source system itself that produces the excitation and stimulation trains of pulses.

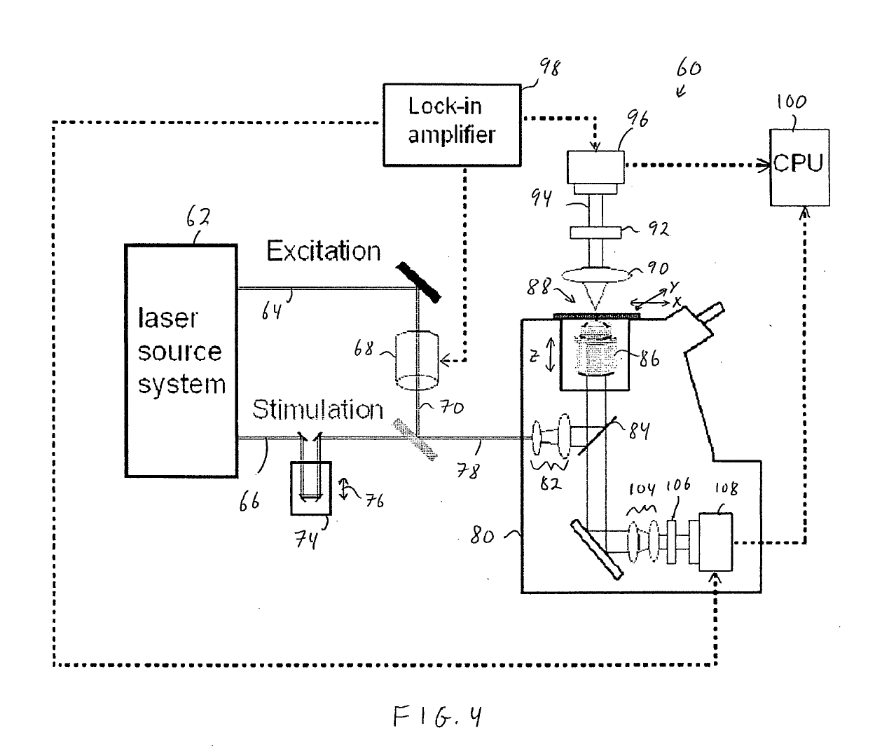

FIG. 4, for example, shows a stimulated emission microscopy system 60 in accordance with an embodiment of the invention that includes a laser source system 62 for providing an excitation beam (e.g., an excitation train of laser pulses 64) at an excitation center frequency we and a stimulation beam (e.g., a stimulation train of laser pulses 66) at a stimulation center frequency ωₛ. The laser source system 62 may include two lasers, or may include one laser, the output of which is used to provide the second train of pulses, for example using an optical parametric oscillator.

Two femptosecond (fs) optical parametric oscillators (OPO), for example, may be synchronously pumped by a fs mode-locked 76 MHz Ti:Sapphire laser. Two frequency-doubled outputs from two OPO signal waves (in the near infrared range), in the wavelength range of 560 to 700 nm and pulse width around 200 fs, may provide the excitation and stimulation pulse trains, respectively. The excitation train of pulses is modulated by a modulator 68, and a modulated excitation train of pulses 70 is combined with the stimulation train of pulses 66 at a combiner 72.

The timing of the stimulation train of laser pulses 66 may be adjusted with respect to the timing of the modulated excitation train of laser pulses 70 by a delay unit 74 that is adjustable as shown at 76. The modulator 68 may, for example, be an acousto-optic modulator that switches the excitation train of pulses on and off at 5 MHz. The combined modulated excitation train of pulses and stimulation train of pulses 78 are provided to a microscope 80.

The microscope 80 includes optics 82 and a reflector system 84 for directing the combined pulses 78 toward an objective 86. The collinear modulated excitation and stimulation beams are focused with a high numerical aperture (N.A.) objective (NA=1.2) onto the common focal spot. T he temporal delay between the synchronized excitation and stimulation inter-pulse is adjusted to about 0.2 ps by using a translational stage. The intensity of the excitation beam is modulated by an acoustics optical modulator at 5 MHz. A condenser with a N.A.=0.9 is used to collect the forward propagating stimulation beam. To acquire images with laser beam scanning, we used a 100 μs time constant for lock-in amplifier and pixel dwell time of 190 μs.

In certain embodiments, the reflector system 84 may include x and y direction scanners (such as mirrors or a scanning light modulator) for scanning in x and y directions on a sample 88. In other embodiments, a stage on which the sample 88 is placed may be adjustable in x and y directions. In certain embodiments, the objective 86 may permit scanning in the z direction.

The tightly focused combined modulated excitation train of pulses and stimulation train of pulses is directed toward the sample 88, and illumination from the sample 88 is collected by lens 90 and filtered by filter 92 (which removes illumination at the excitation frequency), providing filtered illumination 94 that is received by a detector 96 such as a large-area photodiode.

A lock-in amplifier 98 is coupled to both the modulator 68 and the detector 96 such that the modulation may be employed by the detector 96 to identify via image contrast the illumination of interest from filtered illumination 94. The detector 96 provides a detector signal to a processing unit 100, which provides pixel data for an imaging system.

While the filter 92 and detector 96 are located in the forward direction with respect to the objective 86, in further embodiments, the detector and filter may optionally be located in the reverse (epi) direction with respect to the objective 86. For example, as also shown in FIG. 4, the reflector system 84 may be a directional beam splitter and the system may include further optics including a mirror 102, optics 104, a filter 106 and a detector 108 such as a large-area photodiode. The detector 108 is also coupled to the lock-in amplifier 98, and the output of the detector 108 is coupled to the processing unit 100, which again, provides pixel data for the imaging system.

Each excitation pulse from the modulated train of excitation pulses causes chromophores in the sample to change energy states from the low (or ground) state to the electronic excited state, and a quickly following stimulation pulse from the train of stimulation pulses stimulates emission, causing the energy to be released as illumination at the excitation frequency, increasing the total radiative quantum yield by as much as from 10⁻⁵ to unity. As a result, the originally weakly or non-fluorescent species are turned into highly radiating species.

For example, FIG. 5 shows that stimulated emission signal 110 is dependent on the time delay (in picoseconds) between an excitation pulse 112 and a stimulation pulse 114 asymmetrically. The signal vanishes quickly when the excitation pulse lags behind stimulation pulse (negative time delay value). The relative slow decay (˜ps) in the positive delay region reflects the excited state population dynamics. The absolute time zero for pulse overlap is determined by optimizing coherent anti-Stokes Raman scattering signal around 534 nm generated from 590 nm and 660 nm. The signals are taken from 10 μM crystal violet/water solution by using 590 nm and 660 nm as excitation and stimulation beams, respectively.

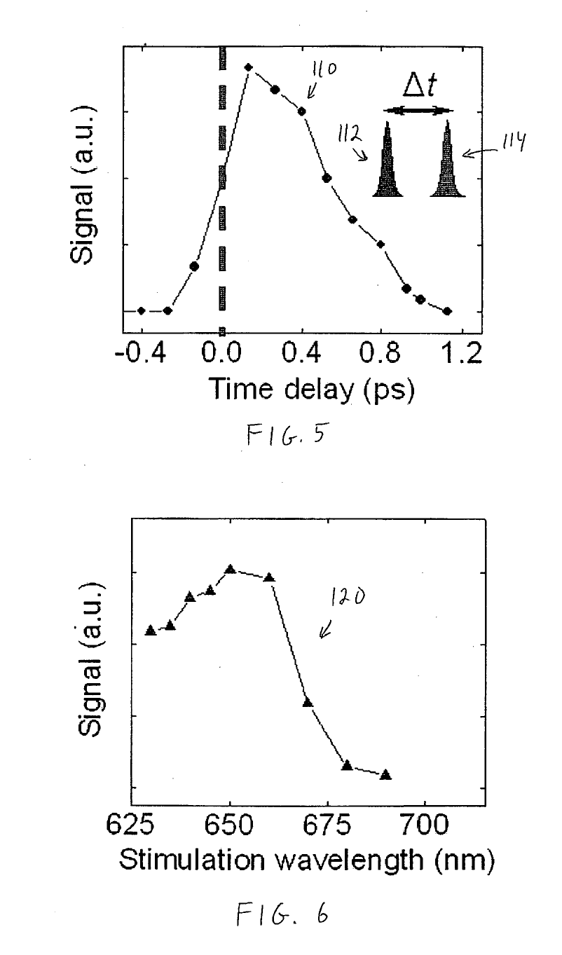

FIG. 6 shows at 120 the measured stimulated emission spectrum of crystal violet in glycerol solution. The excitation beam wavelength was fixed at 590 nm as generally shown at 130 in FIG. 7, and the stimulation wavelength was scanned within a range as shown at 132 in FIG. 7 by tuning an OPO in the laser source system. These results are in agreement with the reported fluorescence spectrum for such a sample.

The measured temporal and spectral dependence of the stimulated emission signal were therefore experimentally confirmed. The time-delay dependence was found to be asymmetric as shown in FIG. 5. When the excitation pulse arrives later than the stimulation pulse, the signal drops as quickly as the pulse width (˜200 fs). On the contrary, the initial growth and relative slow decay (˜ps) of the signal reflects the dynamics of the excited state population of crystal violet in aqueous solution. The recorded stimulated emission spectrum show in FIG. 6 by tuning the wavelength of the stimulated beam is also in agreement with the reported fluorescence spectrum of crystal violet in glycerol solution. Each stimulation pulse of the train of stimulation pulses, therefore, may follow an excitation pulse of the train of excitation pulses by a delay of between about 200 femtoseconds and about 1 picosecond.

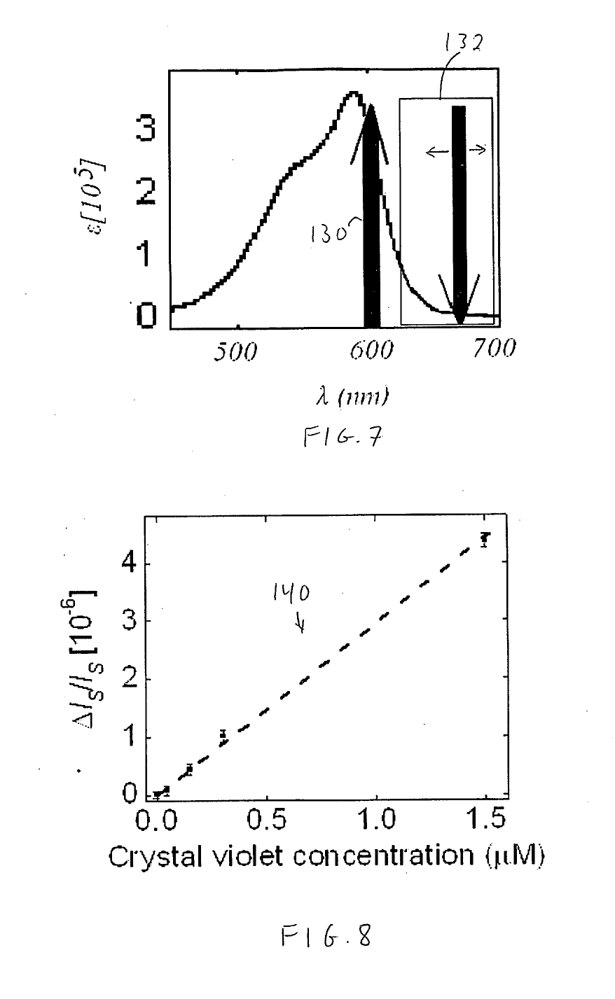

As shown at 140 in FIG. 8, the stimulated emission signal scales linearly with crystal violet analyte concentration in aqueous solution as was predicted by Equation (2) above, which allows straightforward quantitative analysis. Continuous flow of the sample was used to replenish the bleached molecules from the focus. The detection limit was determined to be 60 nM with a signal-to-noise ratio of 1:1. The excitation and stimulation beams are 0.2 and 1 mW, respectively, at the objective focus. For a 1 sec time constant at the lock-in amplifier, a relative signal level of 10⁻⁷ for ΔI_{S}/I_{S} can be routinely detected.

This superb sensitivity in the nano-Molar range (approaching the shot noise limit) corresponds to about a few (<5) molecules within the focal volume of the microscope objective (˜10⁻¹⁶ liter). To detect higher concentration samples, laser power levels may be lowered to reduce photo-bleaching.

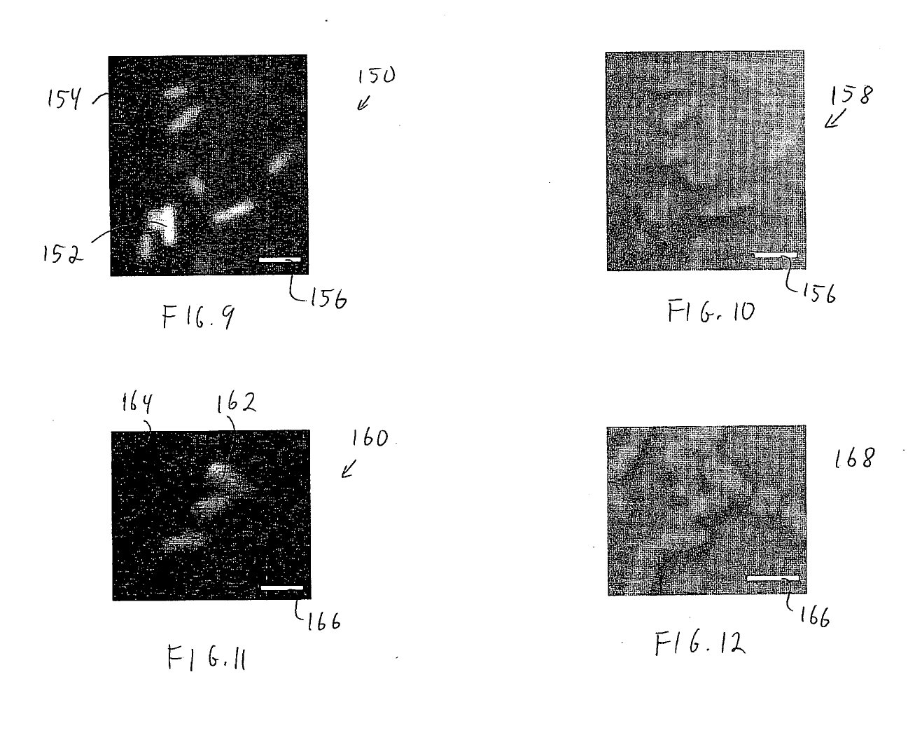

Imaging of live cells has been achieved using stimulated emission systems and methods of the invention. FIGS. 9 and 11 show at 150 and 160 respectively imaging distributions of cytoplasmic chromoproteins gtCP (FIG. 9) and cjBlue (FIG. 11) in live E. coli cells by stimulated emission microscopy. FIGS. 10 and 12 show at 158 and 168 wide-field transmission images of the same samples as used in FIGS. 9 and 11 respectively using direct imaging techniques. Plasmids containing the genes encoded for gtCP and cjBLue are therefore, transformed into E. coli. The gtCP exhibits a maximal absorption around 580 nm, while cjBlue absorbs around 600 nm. Corn pared to gtCP, cjBLue is expressed less abundantly inside cells.

The genetically encodable chromoprotein, such as gtCP and cjBlue, are variants of green fluorescent proteins, and only absorb light but do not fluoresce. When the gene encoding for gtCP is expressed in live E. coli cells, tetrameric gtCP may be clearly shown to reside evenly inside cytoplasm by stimulated emission microscopy, which clearly distinguishes bright colored (e.g., amber colored) areas 152 from the background 154 as shown in FIG. 9. A 2 μm scale bar is shown at 156 in each of FIGS. 9 and 10.

Similarly, when the gene encoding for cjBlue is expressed in live E. coli cells, the cjBlue may be clearly shown to reside evenly inside cytoplasm by stimulated emission microscopy, which clearly distinguishes bright colored (e.g., blue colored) areas 162 from the background 164 as shown in FIG. 11. A 2 μm scale bar is shown at 166 in each of FIGS. 11 and 12. Unlike gtCP which expresses in most of the cells, cjBlue only expresses in a small faction of them. Other endogenous chromoproteins such as hemoglobin and cytochrome c could be imaged in a similar way. Stimulated emission microscopy therefore, opens possibility for studying the biochemistry of these chromoproteins and for utilizing them as genetically encodable imaging probes.

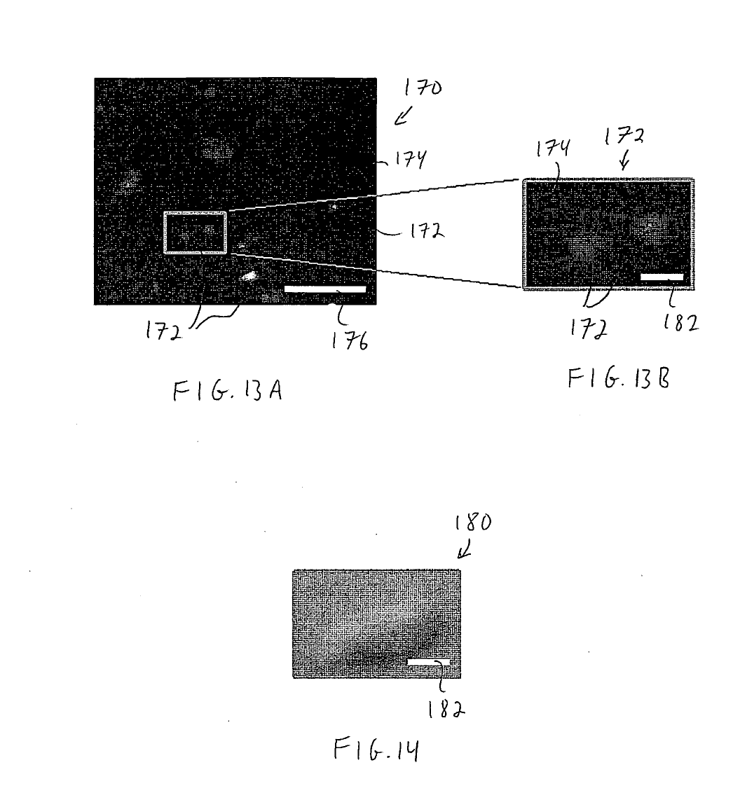

FIGS. 13A and 13B show stimulated emission imaging of lacZ gene expression probed by the hydrolysis of chromogenic substrate X-gal. lacZ gene expression in live E. coli cells is at its basal level without adding inducer. A portion of the image 170 in FIG. 13A is enlarged as shown at 172 in FIG. 13B. Different from the homogeneous protein images in FIGS. 9 and 11, the X-gal hydrolysis product shows inhomogeneous dot-like distribution inside cells (shown as violet color) at 172 as compared to the background 174 due to its insolubility. The excitation and stimulation beams are at 590 nm and 660 nm, respectively. The corresponding direct transmission image shown at 180 in FIG. 14 shows no signs of blue colors from the cells. A 4 μm scale bar is shown at 176 in FIG. 13A, while FIGS. 13B and 14 show a 1 μm scale bar at 182. All of the full scale images were taken within 50 sec.

Since its discovery, lacZ has been a classic reporter for gene expression in various prokaryotic and eukaryotic cells. The protein product, β-galactosidase, encoded by lacZ gene, catalyzes the hydrolysis of X-gal, a popular chromogenic substrate, to form a bluish product. Traditionally, the X-gal hydrolysis product has to accumulate enough for its blue color to be visually seen. With stimulated emission, the basal level lacZ gene expression in the absence of inducer can now be sensitively monitored. Different from the homogeneous chromoprotein images, the more inhomogeneous distribution of X-gal hydrolysis product inside cells (shown in FIG. 13B) is consistent with the fact that X-gal hydrolysis product is insoluble and tends to form small precipitates inside cells. The superb sensitivity of stimulated emission microscopy allows monitoring lacZ reporter gene activity with unprecedented detail.

Applicants have also discovered that the overall quadratic power dependence as outlined above (and as experimentally demonstrated), would allow three-dimensional (3D) optical sectioning, as in many other multi-photon techniques.

FIG. 15 shows at 190 a three dimensional optical sectioning of kidney tissue by stimulated emission microscopy. Cell nuclei are stained by hematoxylin dye. Unlike the traditional linear transmission imaging, stimulated emission microscopy may selectively image at different depths without being affected by an out-of-focus contribution. A 20 μm scale bar 198 is shown in FIG. 15. The open area 192 shows that the dye is clearly visible (in a blue color) at 194 as compared to the background 196.

Imaging medically stained tissues with intrinsic 3D optical sectioning is, therefore, another suitable application for systems of the invention. Various types of chromophore staining are widely used in histology for medical diagnosis. For example, hematoxylin is wisely used to stains basophilic structures such as nuclei. In the conventional approach, thin (˜micron scales) sections have to be physically cut piece-by-piece, because the traditional wide-field transmission microscopy relies on linear absorption and thus does not have optical sectioning ability. Thanks to the nonlinear intensity dependence, stimulated emission microscopy can selectively show images at different depths of stained tissues because the signal is only generated at the laser focus where the laser intensity is the strongest.

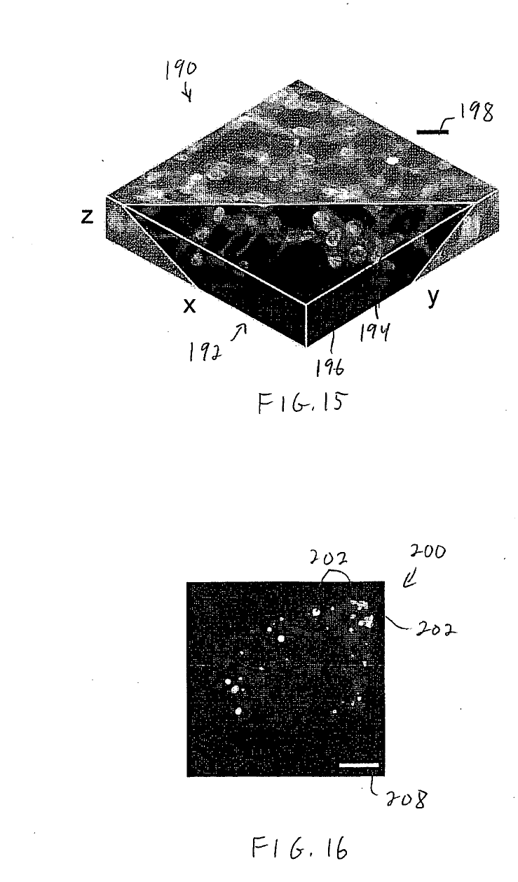

Drug delivery of toluidine blue O (TBO), a drug used as photosensitizer in photodynamic therapy, is shown in FIGS. 16-18. FIG. 16 shows at 200 an image of the drug delivery of toluidine blue O (TBO) in a human embryonic kidney (HEK) 293 cell one hour after incubation of 10 μM TBO/PBS solution. Its local accumulation inside cytoplasm instead of the membrane or nucleus is clearly visible as shown at 202. A 5 μm scale bar 208 is shown in FIG. 16.

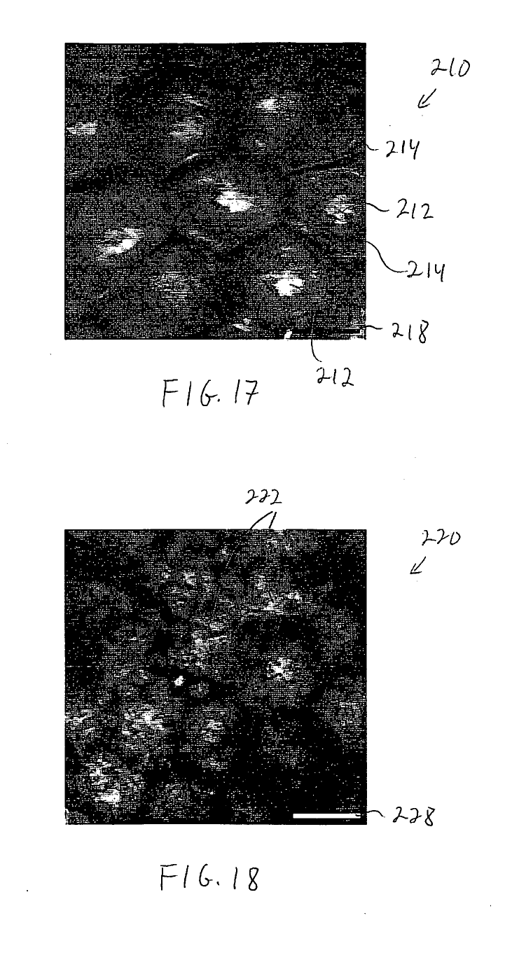

FIGS. 17 and 18 (show at 210 and 220 respectively) the TBO slain distribution in ear tissue at two different depths, 3 and 25 μm, respectively, 30 min after topical application of 10 μM TBO/PBS solution. At the surface layer of stratum corneum, FIG. 17 shows at 212 that the TBO is accumulated in the protein phase of the polygonal cells 214 rather than in the lipid-rich intercellular space. At the layer of viable epidermis, FIG. 18 shows at 222 a rich TBO distribution following the subcellular cytoplasm of nucleated basal keratinocytes. These images in FIGS. 16-18 support the hydrophilic path as a main pathway for transdermal drug delivery of TBO. Excitation and stimulation beams are at 590 nm and 660 nm, respectively. All the 2D images were taken within 50 sec. A 15 μm scale bar 218 is shown in FIG. 17, and a 15 μm scale bar 228 is shown in FIG. 18.

The use of stimulated emission microscopy to monitor drug delivery is therefore demonstrated. In particular, we show mapping of a cationic thiazine dye toluidine blue O (TBO) at both the cellular and tissue levels. Having a selective affinity for cancer cells in vivo, TBO is an actively explored photosensitizer in photodynamic therapy. Subcellular localization of photosensitizers is crucial since it can influence both the level and the kinetics of apoptosis induction. It is conventionally difficult, however, to image the true distribution of TBO because its fluorescence is quenched when bound to tissue substrates and only the non-specific stain residue in the tissue retains its native fluorescence. Because stimulated emission microscopy is independent of fluorescence contrast, it is suitable for addressing this problem.

The stimulated emission image of TBO inside cancer cells after incubation clearly shows its local accumulation inside cytoplasm instead of membrane or nucleus. When topically applied to skin tissue, being hydrophilic and water soluble, TBO is enriched in the center of the protein phase of the polygonal stratum corneum cells rather than in the intercellular space which is in lipid phase. At a 20 μm deeper depth, TBO shows a rich distribution following the subcellular cytoplasm of nucleated viable epidermis in which cellular proliferation actively takes place. These imaging results are consistent with the known high affinity of TBO for cytoplasmic RNA.

Stimulated emission microscopy, therefore, allows detection and imaging of non-fluorescent chromophores such as drug molecules, small dye molecules and proteins in living cells, tissues and organisms with intrinsic 3D optical sectioning and high sensitivity.

Those skilled in the art will appreciate that numerous modifications and variations may be made to the above disclosed embodiments without departing from the spirit and scope of the invention.

What is claimed is:

1. A microscopy imaging system comprising:
a light source system for providing an excitation beam at a center optical frequency ωₑ and for providing a stimulation beam at a center optical frequency ωₛ;
focusing optics for directing and focusing the excitation beam toward a common focal volume such that the sample may be excited to an electronic excited state, and for directing and focusing the stimulation beam toward the common focal volume such that stimulated emission induced from the electronic excited state results in an increase in intensity of the stimulation beam;
an optical detector for detecting an increase in a radiation field at the center optical frequency ωₛ from stimulated emission from the common focal volume and for providing a detector signal; and
a processor for receiving the detector signal and for providing a pixel of an image for the microscopy imaging system.

2. The microscopy imaging system as claimed in claim 1, wherein said excitation beam includes a train of excitation pulses, and wherein said stimulation beam includes a train of stimulation pulses that is synchronized with said train of excitation pulses.

3. The microscopy imaging system as claimed in claim 2, wherein each stimulation pulse of said train of stimulation pulses follows an excitation pulse of the train of excitation pulses by a delay of between about 200 femtoseconds and about 1 picosecond.

4. The microscopy imaging system as claimed in claim 1, wherein at least one of the excitation beam and the stimulation beam is a continuous wave (cw) beam.

5. The microscopy imaging system as claimed in claim 1, wherein said excitation beam is modulated by a modulator.

6. The microscopy imaging system as claimed in claim 5, wherein said optical detector is coupled to a lock-in amplifier that is also coupled to the modulator.

7. The microscopy imaging system as claimed in claim 5, wherein said modulator provides amplitude modulation.

8. The microscopy imaging system as claimed in claim 1, wherein said system further includes scanning optics for positioning said excitation beam from the excitation beam with respect to the common focal volume in x and y directions.

9. The microscopy imaging system as claimed in claim 8, wherein said system further includes scanning optics for positioning said excitation beam from the excitation beam with respect to the common focal volume in a z direction.

10. The microscopy imaging system as claimed in claim 1, wherein said detector is a point photodetector.

11. The microscopy imaging system as claimed in claim 1, wherein said detector is positioned in a reverse (epi-) direction with respect to the sample such that the optical detector detects the increase in the intensity of the stimulation beam from the common focal volume back through at least a portion of the focusing optics.

12. The microscopy imaging system as claimed i claim 1, wherein said focusing optics directs and focuses the excitation beam and the stimulation beam toward the common focal volume as a single beam in which the excitation beam and the stimulation beam are collinear.

13. A method of performing microscopy imaging comprising the steps of:
providing an excitation beam at a center optical frequency ωₑ;
providing a stimulation beam at a center optical frequency ωₛ;
directing and focusing the excitation beam toward a common focal volume such that the sample is excited to an electronic excited state;
directing and focusing the stimulation beam toward the common focal volume such that stimulated emission induced from the electronic excited state produces an increase in intensity of the stimulation beam;
detecting an increase in a radiation field at the center optical frequency ωₛ from stimulated emission from the common focal volume;
providing a stimulated emission detector signal responsive to the increase in the radiation field at the center optical frequency ωₛ from stimulated emission from the common focal volume; and
providing at least a portion of an image responsive to the stimulated emission detector signal.

14. The method as claimed in claim 13, wherein said step of providing said excitation beam includes providing a train of excitation pulses, and wherein said step of providing stimulation beam includes providing a train of stimulation pulses.

15. The method as claimed in claim 13, wherein said step of focusing the excitation beam toward the common focal volume precedes the step of focusing the stimulation beam toward the common focal volume by a predetermined period of time of between about 200 femtoseconds and about 1 picosecond.

16. The method as claimed in claim 15, wherein said predetermined period of time is about one picosecond.

17. The method as claimed in claim 13, wherein said method further includes the step of modulating the excitation beam.

18. The method as claimed in claim 17, wherein the excitation beam is amplitude modulated.

19. The method as claimed in claim 17, wherein said step of providing at least a portion of an image responsive to the stimulated emission detector signal includes employing a lock-in amplifier.

20. The method as claimed in claim 13, wherein said method further includes the step of positioning said excitation beam with respect to the common focal volume in x and y directions.

21. The method as claimed in claim 20, wherein said method further includes the step of positioning said excitation beam with respect to the common focal volume in a z direction.

22. The method as claimed in claim 13, wherein said step of detecting an increase in a radiation field at the center optical frequency ωₛ from stimulated emission from the common focal volume involves using a point photodetector.

23. The method as claimed in claim 13, wherein said excitation beam and said stimulation beam are spatially overlapped with one another and are directed and focused toward a common focal spot.

24. The method as claimed in claim 13, wherein said method provides a high spatial resolution due to the stimulated emission detector signal having a second-order nonlinear intensity dependence.

25. The method as claimed in claim 13, wherein the sample includes chromophores with non-detectable fluorescence.
